(19) United States
(12) Patent Application Publication
(10) Pub. No.: US 2018/0253180 A1
(43) Pub. Date: Sep. 6, 2018

(54) TOUCH SCREEN, TOUCH DISPLAY APPARATUS AND DISPLAY DRIVING METHOD

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Yeqiong Bie, Beijing (CN); Qianqian Wang, Beijing (CN); Lili Yao, Beijing (CN)

(21) Appl. No.: 15/802,039

(22) Filed: Nov. 2, 2017

(30) Foreign Application Priority Data
Mar. 2, 2017 (CN) 201710121412.4

(51) Int. Cl. G06F 3/041; G06F 3/044

(52) U.S. Cl. CPC G06F 3/0416; G06F 2203/04111; G06F 2203/04105; G06F 3/044

(57) ABSTRACT

A touch screen, a touch display apparatus and a display driving method. The touch screen includes: a first substrate; a second substrate, the second substrate and the first substrate being arranged oppositely; and a pressure sensing electrode group. The pressure sensing electrode group includes a first electrode, a second electrode and a conductive spacer, the first electrode is positioned on a side of the first substrate which faces the second substrate, the second electrode is positioned on a side of the second substrate which faces the first substrate, an orthographic projection of the first electrode on the second substrate overlaps with an orthographic projection of the second electrode on the second substrate, one end of the conductive spacer is connected with one of the first electrode and the second electrode, and a height of the conductive spacer is smaller than a distance between the first substrate and the second substrate.

### TECHNICAL FIELD

Embodiments of the present disclosure relate to a touch screen, a touch display apparatus and a display driving method.

### BACKGROUND

In recent years, touch screens are widely applied in fields of electronics, industrial control and the like. Control on a touch display apparatus can be implemented by directly touching a screen of the touch screen, and intuitive and convenient human-machine interaction with simple operations can be implemented. Moreover, along with development of the display technology, the touch screens are more diversified in functions and lower in cost, and yield of the products is also stably improved, so that the touch screens are more and more popularized.

### SUMMARY

In an aspect, embodiments of the disclosure provide a touch screen, comprising: a first substrate; a second substrate, the second substrate and the first substrate being arranged oppositely; and a pressure sensing electrode group, wherein the pressure sensing electrode group includes a first electrode, a second electrode and a conductive spacer, the first electrode is positioned on a side of the first substrate which faces the second substrate, the second electrode is positioned on a side of the second substrate which faces the first substrate, an orthographic projection of the first electrode on the second substrate overlaps with an orthographic projection of the second electrode on the second substrate, one end of the conductive spacer is connected with one of the first electrode and the second electrode, and a height of the conductive spacer is smaller than a distance between the first substrate and the second substrate.

According to embodiments of the disclosure, the touch screen further comprises: a touch detection electrode group, wherein the touch detection electrode group includes a third electrode and one of the first electrode and the second electrode.

According to embodiments of the disclosure, the third electrode is arranged on a side of the first substrate which is far away from the second substrate.

According to embodiments of the disclosure, the third electrode is arranged between the first substrate and the second substrate.

According to embodiments of the disclosure, the first substrate is a color filter substrate, and the second substrate is an array substrate; or the first substrate is the array substrate, and the second substrate is the color filter substrate.

According to embodiments of the disclosure, the first electrode and the second electrode are strip electrodes respectively.

According to embodiments of the disclosure, the first electrode is formed by arranging a plurality of blocky first sub-electrodes into a strip shape, and the second electrode is formed by arranging a plurality of blocky second sub-electrodes into a strip shape.

According to embodiments of the disclosure, the third electrode is a strip electrode, and an orthographic projection of the third electrode on the first substrate is perpendicular to the first electrode.

According to embodiments of the disclosure, the third electrode is formed by arranging a plurality of blocky third sub-electrodes into a strip shape.

According to embodiments of the disclosure, the touch screen further comprises: a first alignment film, wherein the first alignment film is arranged on a surface of the side of the first substrate which faces the second substrate, and at least one portion of the first electrode is embedded into the first alignment film; and a second alignment film, wherein the second alignment film is arranged on a surface of the side of the second substrate which faces the first substrate, and at least one portion of the second electrode is embedded into the second alignment film.

According to embodiments of the disclosure, the touch screen further comprises: a primary spacer, wherein the primary spacer is arranged between the first substrate and the second substrate, the primary spacer is used for supporting the first substrate and the second substrate, and the primary spacer and the conductive spacer are arranged alternately.

According to embodiments of the disclosure, the touch detection electrode group includes the first electrode and the third electrode; the first electrode is used as a pressure sensing receiving electrode and a touch receiving electrode, the second electrode is used as a pressure sensing driving electrode, and the third electrode is used as a touch driving electrode; or the first electrode is used as the pressure sensing driving electrode and the touch driving electrode, the second electrode is used as the pressure sensing receiving electrode, and the third electrode is used as the touch receiving electrode.

According to embodiments of the disclosure, the touch detection electrode group includes the second electrode and the third electrode; the second electrode is used as a pressure sensing receiving electrode and a touch receiving electrode, the first electrode is used as a pressure sensing driving electrode, and the third electrode is used as a touch driving electrode; or the second electrode is used as the pressure sensing driving electrode and the touch driving electrode, the first electrode is used as the pressure sensing receiving electrode, and the third electrode is used as the touch receiving electrode.

In another aspect, embodiments of the disclosure provide a touch display apparatus, comprising: the above touch screen; and a control circuit, including a touch detection circuit and a pressure detection circuit, wherein: the pressure detection circuit is electrically connected with the pressure sensing electrode group, and is configured to detect a touch pressure applied to the touch screen; and the touch detection circuit is electrically connected with a touch detection electrode group, and is configured to detect a touch position on the touch screen.

In yet another aspect, embodiments of the disclosure provide a display driving method for the above touch display apparatus, comprising: when the touch display apparatus is pressed and a first electrode and a second electrode at a pressed position are electrically connected by a conductive spacer, transmitting a first signal by one of the first electrode and the second electrode, receiving a second signal by the other one of the first electrode and the second electrode, detecting a conduction condition between the first electrode and the second electrode through the conductive spacer by the pressure detection circuit, and determining a conduction electricity quantity correspondingly generated by a pressing operation; and inquiring a preset first control strategy to acquire a first control instruction corresponding to the conduction electricity quantity, and starting a corresponding touch function according to the first control instruction.

According to embodiments of the disclosure, inquiring the preset first control strategy to acquire the first control instruction corresponding to the conduction electricity quantity includes: inquiring a conduction electricity quantity range at each level in the first control strategy, and acquiring a electricity quantity range at a target level corresponding to the detected conduction electricity quantity; and inquiring a corresponding relationship between levels of electricity quantity ranges and functional control instructions in the first control strategy, and acquiring the first control instruction corresponding to the electricity quantity range at the target level.

According to embodiments of the disclosure, the display driving method further comprises: when the third electrode transmits a third signal, detecting a capacitance change condition between the third electrode and the other one of the first electrode and the second electrode by the touch detection circuit, and determining touch point coordinates corresponding to a touch operation; and inquiring a preset second control strategy to acquire a second control instruction corresponding to the touch point coordinates, and starting a corresponding touch function according to the second control instruction.

### BRIEF DESCRIPTION OF THE DRAWINGS

In order to illustrate the technical solutions in the embodiments of the present disclosure or the existing arts more clearly, the drawings needed to be used in the description of the embodiments or the existing arts will be briefly described in the following; it is obvious that the drawings described below are only related to some embodiments of the present disclosure, for one ordinary skilled person in the art, other drawings can be obtained according to these drawings without making other inventive work.

FIG. 1A shows a structural schematic diagram of a touch screen according to one embodiment of the present disclosure;

FIG. 1B shows a structural schematic diagram of a touch screen according to another embodiment of the present disclosure;

FIG. 2 shows a structural schematic diagram of a touch screen according to another embodiment of the present disclosure;

FIG. 3 shows a schematic diagram of pressure sensing of a touch screen according to one embodiment of the present disclosure;

FIG. 4 shows a structural schematic diagram of a touch screen according to yet another embodiment of the present disclosure;

FIG. 5 shows a structural schematic diagram of a touch screen according to still yet another embodiment of the present disclosure;

FIG. 6 shows a structural schematic diagram of a touch screen according to still yet another embodiment of the present disclosure;

FIG. 7 shows a partial structural schematic diagram of a touch screen according to one embodiment of the present disclosure;

FIG. 8 shows a partial structural schematic diagram of a touch screen according to another embodiment of the present disclosure;

FIG. 9 shows a partial structural schematic diagram of a touch screen according to yet another embodiment of the present disclosure;

FIG. 10 shows a structural schematic diagram of a touch screen according to yet another embodiment of the present disclosure; and

FIG. 11 shows a structural diagram of a touch display apparatus according to an embodiment of the present disclosure.

### REFERENCE SIGNS

100: first substrate; 10: pressure sensing electrode group; 11: first electrode; 12: conductive spacer; 110: first alignment film; 200: second substrate; 13: second electrode; 20: touch detection electrode group; 21: third electrode; 210: second alignment film; 300: polarizer of the color filter substrate; 400: backlight module; 30: primary spacer.

### DETAILED DESCRIPTION

The embodiments of the present disclosure will be described in detail below, and examples of the embodiments are shown in the drawings, wherein same or similar signs represent same or similar elements or elements with same or similar functions from beginning to end. The embodiments described with reference to the drawings are exemplary, only used for explaining the present disclosure, but cannot be understood as limitation to the present disclosure.

Along with popularization of touch screens, the touch screens gradually replace functions of keyboards of small-sized electronic devices, such as a mobile phone, a tablet personal computer or a vehicle-mounted navigator and the like. Both input of information and selection of an application can be implemented by carrying out a touch operation on a touch screen. Along with rapid development of the electronic technology, a present small-sized touch display apparatus can achieve very rich functions. Correspondingly, the touch screens also need to be multi-functionalized so as to achieve the rich functions by a simple touch operation. Currently, touch screens capable of carrying out pressure detection appear. Relative to an operation of multipoint touch in a two-dimensional plane space, the pressure-detection touch screen adds perception on a touch intensity and a touch area, and thus, touch functions of the touch screens are enriched.

Embodiments of the present disclosure provide a touch screen which is simple in structure and can effectively implement pressure classification detection. The touch screen can simply and conveniently implement detection on a plane two-dimensional point and a three-dimensional touch intensity, the pressure detection do not affect other functions of the touch screen, and the touch screen has the advantages of simple structure, sensitivity for sensing and the like.

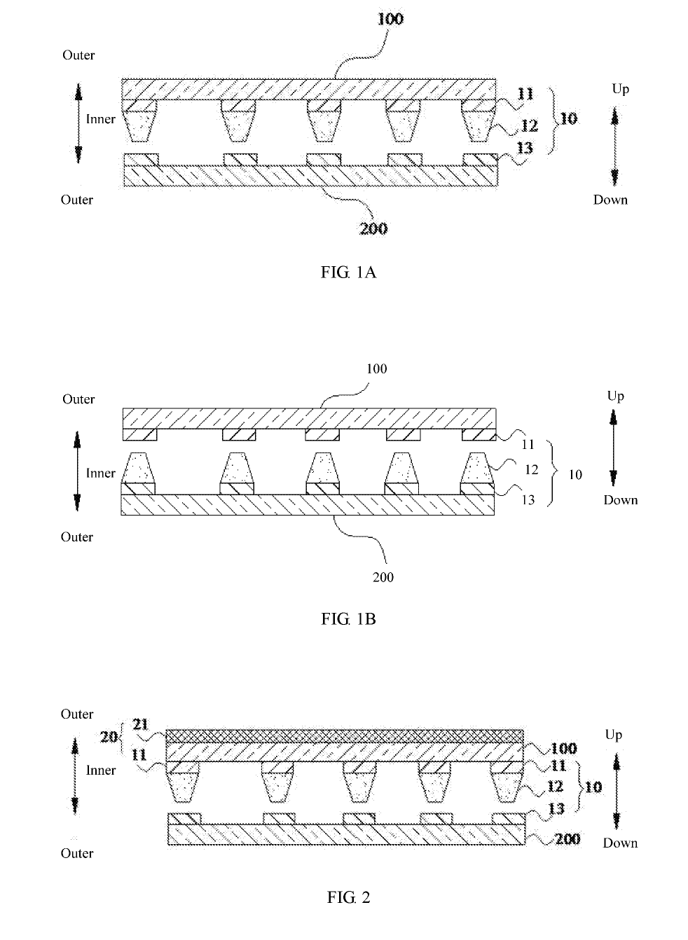

In one aspect, an embodiment of the present disclosure provides a touch screen. According to an embodiment of the present disclosure, as shown in FIG. 1A, the touch screen includes: a first substrate 100, a second substrate 200 and one or more pressure sensing electrode groups 10. For example, the second substrate 200 and the first substrate 100 are arranged oppositely, and each pressure sensing electrode group 10 includes a first electrode 11, a second electrode 13 and a conductive spacer 12. The first electrode 11 is positioned on one side of the first substrate 100, the one side of the first substrate 100 facing the second substrate 200; and the second electrode 13 is positioned on one side of the second substrate 200, the one side of the second substrate 200 facing the first substrate 100. An orthographic projection of the first electrode 11 on the second substrate 200 overlaps with an orthographic projection of the second electrode 13 on the second substrate 200. For example, the orthographic projection of the first electrode 11 on the second substrate 200 completely or at least partially overlaps with the orthographic projection of the second electrode 13 on the second substrate 200. One end of the conductive spacer 12 is connected with one of the first electrode 11 and the second electrode 13, and a height of the conductive spacer 12 is smaller than a distance between the first substrate 100 and the second substrate 200. For example, one end of the conductive spacer 12 is connected with one of the first electrode 11 and the second electrode 13, and the other end of the conductive spacer 12 is separated from the other one of the first electrode 11 and the second electrode 13. In other words, one end of the conductive spacer 12 can be connected with the first electrode 11, and the other end of the conductive spacer 12 can be separated from the second electrode 13 (as shown in FIG. 1A); or, one end of the conductive spacer 12 can be connected with the second electrode 13, and the other end of the conductive spacer 12 can be separated from the first electrode 11 (as shown in FIG. 1B). For example, the conductive spacer 12 may be arranged on the first electrode 11 and is oppositely disposed with respect to the second electrode 13; or, the conductive spacer 12 may be arranged on the second electrode 12 and is oppositely disposed with respect to the first electrode 11.

In order to facilitate understanding, firstly, a pressure sensing principle of the pressure sensing electrode group 10 will be illustrated briefly below. When the touch screen is not pressed by an external force, the first electrode 11 and the second electrode 13 in each pressure sensing electrode group 10 are disconnected, and at this point, each pressure sensing electrode group 10 is in a turn-off state; and when the touch screen is pressed and touched by a force pointing from outside towards inside of the touch screen, the first substrate 100 is deformed under the action of the external force and is bent inwards in a up-to-down direction. At this point, a distance between the first substrate 100 and the second substrate 200 is reduced, leading to a case that the conductive spacer 12 at a stressed position is in contact with the corresponding second electrode 13 due to moving downward along with downward deformation of the first substrate 100. At this point, the corresponding first electrode 11 at the stressed position is electrically connected with the corresponding second electrode 13 via the conductive spacer 12, and at this point, the pressure sensing electrode group 10 at the stressed position is in a turn-on state. The greater the deformation amount of the first substrate 100 is, the more the conducted pressure sensing electrode groups 10 at the stressed position are. A deformation degree of the first substrate 100 is related to a size of a pressure applied to the first substrate 100, and thus, detection and classification on the touch pressure can be simply and conveniently implemented.

It should be noted that in the present disclosure, “the orthographic projection of the first electrode 11 on the second substrate 200 overlaps with the orthographic projection of the second electrode 13 on the second substrate 200” should be understood broadly. For example, the orthographic projection of the first electrode 11 on the second substrate 200 completely overlaps with the orthographic projection of the second electrode 13 on the second substrate 200. For further example, the orthographic projection of the first electrode 11 on the second substrate 200 overlaps with a portion of the orthographic projection of the second electrode 13 on the second substrate 200. For still further example, a portion of the orthographic projection of the first electrode 11 on the second substrate 200 overlaps with the orthographic projection of the second electrode 13 on the second substrate 200. As previously mentioned, according to embodiments of the present disclosure, in the pressure sensing electrode groups 10, detection and classification of the pressure are determined by detecting the number of the first electrodes 11 and the second electrodes 13 that are connected to each other. Therefore, a relative position relationship among the first electrode 11, the second electrode 13 and the conductive spacer 13 may be set to meet the following relationship that: in a process that the conductive spacer 12 is bent inwards along with the pressure, the first electrode 11 at the stressed position can be in contact with one second electrode 13, and electrical connection of the first electrode 11 and the second electrode 13 is achieved.

According to an embodiment of the present disclosure, with reference to FIG. 2, the touch screen further includes: a touch detection electrode group 20. According to embodiments of the present disclosure, the touch detection electrode group 20 includes a first touch electrode and a second touch electrode. The first touch electrode may be a touch receiving electrode Rx (or, a touch driving electrode Tx), and correspondingly, the second touch electrode is a touch driving electrode Tx (or, a touch receiving electrode Rx). The first touch electrode may be the first electrode 11 or the second electrode 13, and the second touch electrode may be a third electrode 21. Therefore, detection on a touch position can be implemented by utilizing the third electrode 21 and the first electrode 11 (or, the third electrode 21 and the second electrode 13), which is beneficial for simplifying the structure of the touch screen.

For example, according to embodiments of the present disclosure, the first electrode 11 may be arranged on the first substrate 100, and the second electrode 13 may be arranged on the second substrate. In a first example, the first electrode 11 may be the first touch electrode (for example, the touch receiving electrode (Rx)), and the third electrode 21 may be the second touch electrode (for example, the touch driving electrode Tx); and the second electrode 13 may be a pressure sensing driving electrode (P_Tx), and the first electrode 11 is also multiplexed as a pressure sensing receiving electrode (P_Rx). The third electrode 21 and the second electrode 13 transmit driving signals at different times (i.e., time-sharing of touch detection driving and pressure sensing driving is implemented). In a second example, the first electrode 11 may be the first touch electrode (for example, the touch driving electrode Tx), and the third electrode 21 may be the second touch electrode (for example, the touch receiving electrode Rx); and the second electrode 13 may be the pressure sensing receiving electrode (P_Rx), and the first electrode 11 is multiplexed as the pressure sensing driving electrode (P_Tx). No matter in the first example or the second example, the first electrode 11 and the third electrode 21 form the touch detection electrode group 20 to implement detection on a touch position; and meanwhile, the first electrode 11, the second electrode 13 and the conductive spacer 12 form the pressure sensing electrode group 10 to implement detection on the touch pressure. Therefore, multiplexing of the first electrode 11 is implemented, and the structure of the touch screen is simplified.

Certainly, the structure of the touch screen may also be simplified by multiplexing of the second electrode 13. In a third example, the second electrode 13 may be the first touch electrode (for example, the touch receiving electrode (Rx)), and the third electrode 21 may be the second touch electrode (for example, the touch driving electrode Tx); and the first electrode 11 may be the pressure sensing driving electrode (P_Tx), and the second electrode 13 is multiplexed as the pressure sensing receiving electrode (P_Rx). In a fourth example, the second electrode 13 may be the first touch electrode (for example, the touch driving electrode Tx), and the third electrode 21 may be the second touch electrode (for example, the touch receiving electrode Rx); and the first electrode 11 may be the pressure sensing receiving electrode (P_Rx), and the second electrode 13 is multiplexed as the pressure sensing driving electrode (P_Tx). No matter in the third example or the fourth example, the second electrode 13 and the third electrode 21 form the touch detection electrode group 20 to implement detection on the touch position; and meanwhile, the first electrode 11, the second electrode 13 and the conductive spacer 12 form the pressure sensing electrode group 10 to implement detection on the touch pressure. Therefore, multiplexing of the second electrode 13 is implemented, and the structure of the touch screen is simplified.

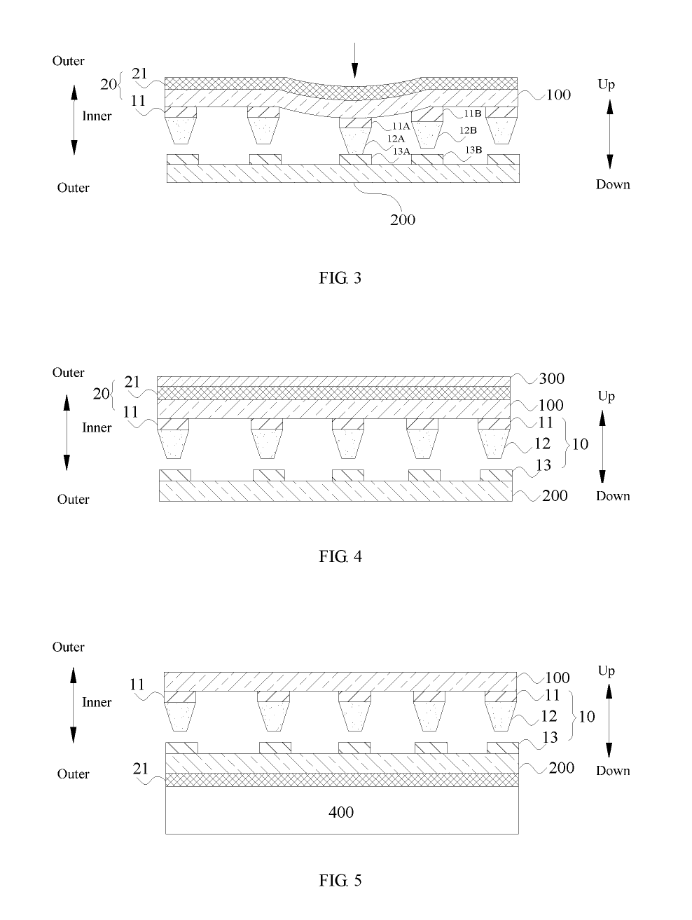

According to a specific embodiment of the present disclosure, with reference to FIG. 3, when the touch screen is subjected to a touch operation from a touch object (a finger of a user or a stylus), the first substrate 100 is deformed at the touch position. At this point, a capacitance between a first electrode 11A and the third electrode 21 at the touch position is changed, and a touch detection chip (for example, an Integrated Circuit (IC) chip) can calculate coordinates where the touch operation is implemented by detecting an intersection point where the capacitance value changes, so as to implement the touch function of the touch screen on a two-dimensional plane. Moreover, due to deformation of the first substrate 100, a distance between the first electrode 11A and a second electrode 13A is reduced, and the first electrode 11A and the second electrode 13A may be electrically connected by a conductive spacer 12A at this moment. For example, a connected first pressure sensing electrode group 10 includes the first electrode 11A, the second electrode 13A and the conductive spacer 12A. When the touch pressure is increased, the deformation amount of the first substrate 100 is increased, or when the touch area is increased, a first electrode 11B adjacent to the first electrode 11A also achieves electrical connection with a second electrode 13B through a corresponding conductive spacer 12B. For example, a connected second pressure sensing electrode group 10 includes the first electrode 11B, the second electrode 13B and the conductive spacer 12B. Therefore, a current or voltage value between the first electrodes 11 and the second electrodes 13, which is detected by the touch chip, is also changed along with the change of the number of the connected pressure sensing electrode groups 10. At this point the touch chip can implement classification processing on pressure signals according to the detected current or voltage signals, and implement control on different functions of the touch screen based on different classification pressure signals. It should be noted that approaches in which the touch chip carries out detection on a plurality of pressure sensing electrode groups 10 and touch detection electrode groups are not specially limited herein. According to embodiments of the present disclosure, the third electrode 21 may be set as an electrode capable of transmitting signals; one of the first electrode 11 and the second electrode 13, which does not form a touch detection electrode group 20 with the third electrode 21, may also be an electrode capable of transmitting signals. Moreover, the third electrode 21 and the one of the first electrode 11 and the second electrode 13 (which does not form the touch detection electrode group 20 with the third electrode 21) do not simultaneously transmit the signals. Therefore, time-sharing driving of touch detection and pressure sensing can be implemented.

According to embodiments of the present disclosure, a specific arranged position of the third electrode 21, a placing approach, and an approach in which the touch detection electrode group 20 implements the touch detection are all not specially limited. For example, according to an embodiment of the present disclosure, the touch detection electrode groups 20 may implement detection on a touch site using a self-capacitive or mutual-capacitive approach. The third electrode 21 may be arranged on the first substrate 100, or may be arranged above the first substrate 100, or may be arranged below the second substrate 200. Or, the third electrode 21 may be arranged between the first substrate 100 and the second substrate 200. The third electrode 21 and the first electrode 11 may be arranged on the same side of the first substrate 100, and the third electrode 21 and the first electrode 11 may also be respectively arranged on two sides of the first substrate 100. Specific types of the first substrate 100 and the second substrate 200 are not limited. For example, according to an embodiment of the present disclosure, one of the first substrate 100 and the second substrate 200 may be a color filter substrate, and the other one is an array substrate. Namely, the first substrate 100 may be the color filter substrate, and the second substrate 200 may be the array substrate; or, the first substrate 100 may be the array substrate, and the second substrate 200 may be the color filter substrate. By taking a case that the first substrate 100 may be the color filter substrate and the second substrate 200 may be the array substrate as an example, the third electrode 21 may be arranged on one side of the color filter substrate, the one side of the color filter substrate being far away from the array substrate. For example, the third electrode 21 may be arranged between the color filter substrate and a polarizer of the color filter substrate, or arranged between the polarizer of the color filter substrate and a protective cover board; or, the third electrode 21 may be arranged between the color filter substrate and the array substrate, as long as insulating layers are disposed between the third electrode 21 and the first electrode 11 as well as the second electrode 13. For further example, the third electrode 21 may be arranged between the array substrate and a backlight unit. A space for filling up liquid crystals needs to be reserved between the color filter substrate and the array substrate of the touch screen, and thus, when the first substrate 100 and the second substrate 200 are respectively the color filter substrate and the array substrate, it is beneficial to utilize the liquid crystal filling space to arrange the pressure sensing electrode groups 10. Therefore, without obviously increasing a thickness of the touch screen, arrangement of the pressure sensing electrode groups 10 can be implemented.

According to embodiments of the present disclosure, with reference to FIG. 3, the third electrode 21 may be arranged on a surface of a side of the first substrate 100 which is far away from the second substrate 200. In other words, the third electrode 21 and the first electrode 11 are respectively arranged on two sides of the first substrate 100. Therefore, increase of the manufacture flow and cost caused by arranging the third electrode 21 and the first electrode 11 on the same side can be avoided, and loss on a production yield which may be increased if the third electrode 21 and the first electrode 11 need to be arranged on the same side can be avoided.

According to another embodiment of the present disclosure, with reference to FIG. 4, by taking a case that the first substrate is the color filter substrate as an example, the third electrode 21 may also be arranged between the polarizer 300 of the color filter substrate and the color filter substrate. Therefore, it is beneficial for further improving touch detection sensitivity of the touch screen. Or, the third electrode 21 can also be arranged on one side of the polarizer 300 of the color filter substrate which is far away from the color filter substrate; in other words, the third electrode 21 can be arranged between the polarizer 300 of the color filter substrate and the protective cover board (not shown in the drawing). Therefore, it is beneficial for shortening a distance between the third electrode 21 and an object which applies a touch operation, thereby beneficial for further improving touch detection sensitivity of the touch screen.

According to an embodiment of the present disclosure, with reference to FIG. 5, by taking the second substrate 200 as an example, the third electrode 21 may also be arranged on one side of the array substrate which is far away from the color filter substrate. In other words, the third electrode 21 may be arranged between the array substrate and a backlight module 400. Therefore, a sufficient deformation space can be reserved between the third electrode 21 and a corresponding first electrode 11 (or the second electrode 13) which forms a touch detection electrode group with the third electrode 21, thereby beneficial for further improving touch detection sensitivity of the touch screen.

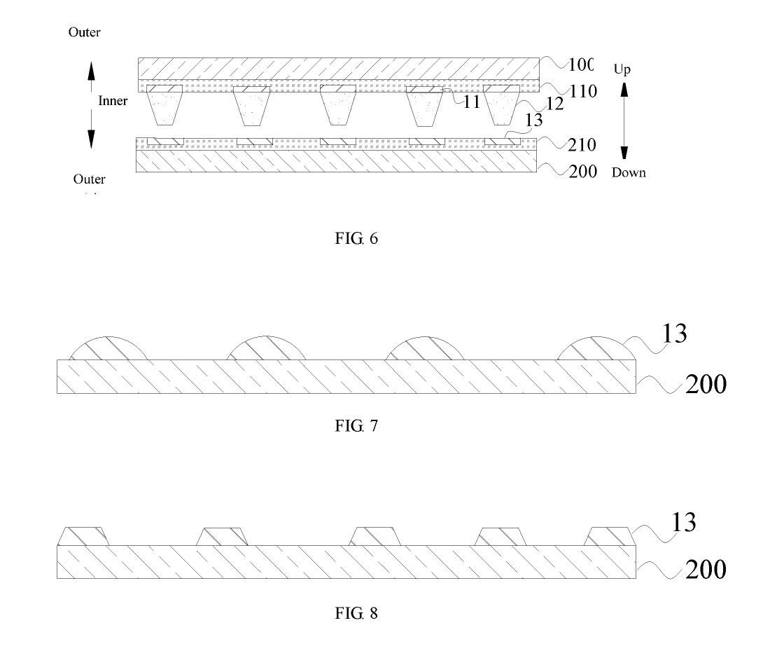

According to an embodiment of the present disclosure, with reference to FIG. 6, the touch screen can further include a first alignment film 110 and a second alignment film 210. Particularly, the first alignment film 110 is arranged on a surface of one side of the first substrate 100 which faces the second substrate 200, and the second alignment film 210 is arranged on a surface of one side of the second substrate 200 which faces the first substrate 100. In order to further save space of the touch screen and not to increase the thickness of the touch screen when adding a pressure detection function, the first alignment film 110 and the second alignment film 210 can be subjected to hole digging processing, and the first electrode 11 and the second electrode 13 are accommodated at hole-dug positions. In other words, at least a portion of the first electrode 11 can be embedded into the first alignment film 110, and at least a portion of the second electrode 13 can also be embedded into the second alignment film 210. For example, the first electrode 11 can be totally embedded into the first alignment film 110, and the second electrode 13 can also be totally embedded into the second alignment film 210. Therefore, the structure of the touch screen can be further simplified to save space. By carrying out the hole digging processing on the alignment films (the first alignment film 110 and the second alignment film 210) and arranging the first electrode 11 and the second electrode 13 thereof, negative effects of the first electrode 11 and the second electrode 13 on other electrical structures in the touch screen can also be avoided, and an alignment electric field between the first substrate 100 and the second substrate 200 cannot be influenced.

According to an embodiment of the present disclosure, the first electrode 11 and the second electrode 13 may be strip electrodes. It should be noted that in the present disclosure, a “strip electrode” should be broadly understood. Particularly, at least one of the first electrode 11 and the second electrode 13 can be formed by a rectangular metal strip. Or, the first electrode 11 may include a plurality of blocky first sub-electrodes, the plurality of first sub-electrodes are arranged along a same straight line and are connected with each other through wires, and outlines of the plurality of blocky first sub-electrodes form a strip shape. Similarly, the second electrode 13 may also include a plurality of blocky second sub-electrodes. Longitudinal cross-sections of the first electrode 11 and the second electrode 13 can respectively and independently have a shape of at least one of a rectangular shape, a trapezoid shape and an arc shape. According to an embodiment of the present disclosure, with reference to FIG. 7 and FIG. 8, longitudinal cross-sections of the plurality of second electrodes 13 may be all of an arc shape or a trapezoid shape; or, the longitudinal cross-sections of the second electrodes 13 arranged on the second substrate 200 may also have other different shapes. Therefore, the shapes of the second electrodes 13 at different positions can be designed as needed so as to facilitate arrangement of other parts in the touch screen or save the space for electrode routing. The longitudinal cross-sections of the first electrodes 11 and the longitudinal cross-sections of the second electrodes 13 are similar in design, which is not repeated herein, as long as the longitudinal cross-sections of the first electrodes 11 and the second electrodes 13 are arranged to facilitate implementing electrical connection by the conductive spacers 12.

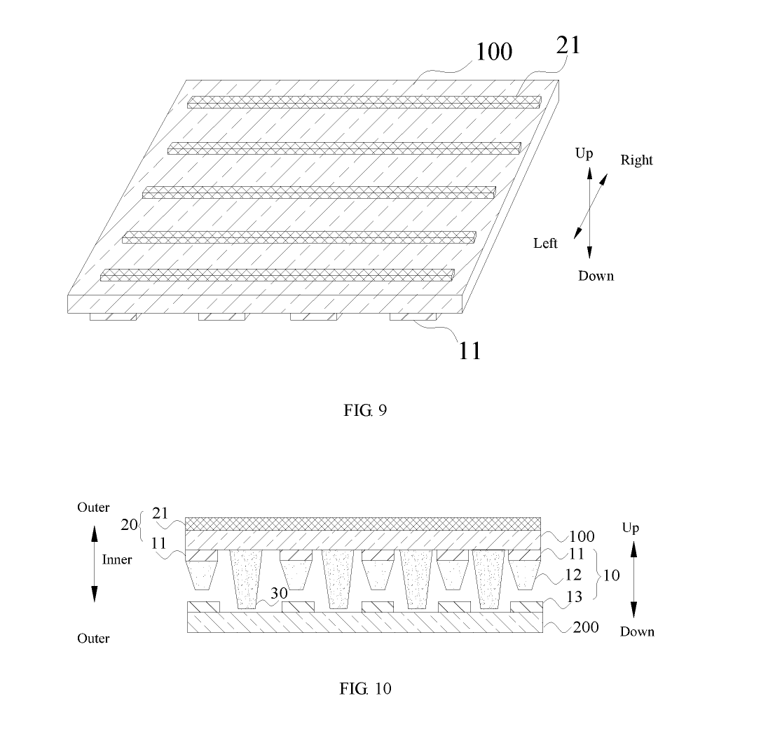

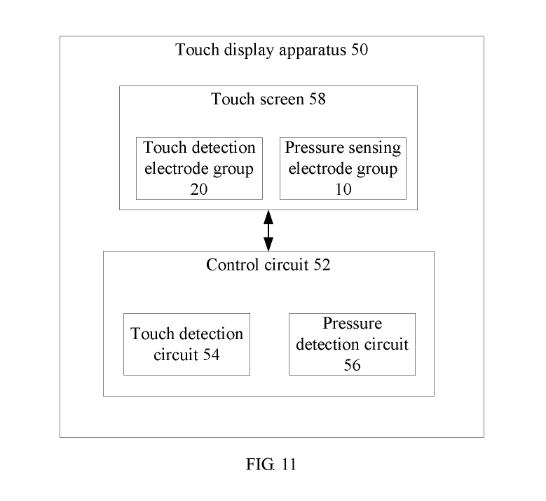

According to an embodiment of the present disclosure, the third electrode 21 may be a plate electrode, and may also be a strip electrode. According to an embodiment of the present disclosure, with reference to FIG. 9, the third electrode 21 may be the strip electrode, and an orthographic projection of the third electrode 21 on the first substrate is perpendicular to the first electrode 11. Similarly, the third electrode 21 may also include a plurality of blocky third sub-electrodes, and the plurality of blocky third sub-electrodes are arranged along a same straight line and are connected with each other by wires. By taking a case that the third electrode 21 is arranged on an upper surface of the first substrate 100 as an example, both the third electrodes 21 and the first electrodes 11 may be strip electrodes, and the third electrodes 21 and the first electrodes 11 can respectively form electrode network patterns perpendicular to each other on the upper and lower surfaces of the first substrate 100. A plurality of third electrodes 21 may be arranged in parallel to form row electrodes, and a plurality of first electrodes 11 may form column electrodes. Since the orthographic projections of the first electrodes 11 on the second substrate 200 overlap with the orthographic projections of the second electrodes 13 on the second substrate 200, the second electrodes 13 are also of a column electrode structure.

According to an embodiment of the present disclosure, the shape of a longitudinal cross-section of a third electrode 21 is also not specially limited, and may be at least one of a rectangular shape, a trapezoid shape, a triangular shape and an arc shape. The longitudinal cross-sections of the plurality of third electrodes 21 can be the same, and can also be different in shapes.

According to an embodiment of the present disclosure, with reference to FIG. 10, the touch screen may also further include primary spacers 30. The primary spacers 30 are arranged between the first substrate 100 and the second substrate 200, and the primary spacers 30 are used for supporting the first substrate 100 and the second substrate 200. In other words, a height of the primary spacers 30 is greater than a height of the conductive spacers 12. When the first substrate 100 and the second substrate 200 respectively are the color filter substrate and the array substrate, liquid crystal molecules can be filled between the first substrate 100 and the second substrate 200 and frame sealing processing is carried out so as to achieve a display function of the touch screen. At this point, isolation of the liquid crystal molecules among different sub-pixels can be implemented by utilizing the primary spacers 30 so as to beneficially improve the display function of the touch screen.

According to an embodiment of the present disclosure, the primary spacers 30 and the conductive spacers 12 may be arranged alternately. Both the primary spacers 30 and the conductive spacers 12 may be formed by polymer, and the conductive spacer 12 may include polymer with conductive particles. In other words, a main body structure of the conductive spacers 12 can be formed by polymer, and a conductive function can be achieved by adding the conductive particles into the polymer. Therefore, the primary spacers 30 and the conductive spacers 12 can be synchronously manufactured by utilizing methods of polymer pouring formation or photoetching and the like so as to beneficially shorten the manufacture process of preparing the touch screen and beneficially improve production efficiency and reduce production cost. For example, different from the conductive spacers 12, the primary spacers 30 do not have the conductive function.

From the above, the touch screen according to the embodiments of the present disclosure has, but not limited to, the following advantages including:

(1) the structure is simple, and detection on the touch position and the touch pressure can be implemented only by carrying out improvement on existing touch screens, which are beneficial for large-scale popularization and application of the touch screen;

(2) the pressure sensing electrode groups are arranged in the liquid crystal filling space of the touch screen, and arrangement of the pressure sensing electrode groups can be implemented in the premise of not obviously increasing the thickness of the touch screen; and

(3) the pressure sensing electrode groups can simply, conveniently and flexibly implement detection and classification on the pressure, and do not cause negative effects on the functions of other electronic parts in the touch screen.

In another aspect, an embodiment of the present disclosure discloses a touch display apparatus 50. According to embodiments of the present disclosure, the touch display apparatus 50 includes: any above-mentioned touch screen 58 and a control circuit 52. The touch display apparatus 10 includes any one of the above-mentioned touch screens, and thus, the touch display apparatus has all characteristics and advantages of any one of the above-mentioned touch screens, which are not repeated herein. The touch display apparatus has at least one of the advantages of simple structure, high sensing sensitivity, capability of simultaneously achieving functions of detecting the pressure and the touch site and the like.

According to embodiments of the present disclosure, the control circuit 52 includes a touch detection circuit 54 and a pressure detection circuit 56, wherein the pressure detection circuit 56 is electrically connected with the pressure sensing electrode groups 10 for detecting the touch pressure applied to the touch screen, and the touch detection circuit 54 is electrically connected with the touch detection electrode groups 20 for detecting the touch position on the touch screen. According to embodiments of the present disclosure, the third electrode 21 in a touch detection electrode group can be set to have capability of transmitting signals, and the touch detection circuit 54 is communicatively connected with the third electrode 21, so as to transfer the signals transmitted by the third electrode 21 to the touch detection circuit 54 to carry out detection, thereby determining the touch position. In the pressure sensing electrode group, an electrode (the first electrode 11 or the second electrode 13) which does not form the pressure sensing group with the third electrode 21 can also be set to have capability of transmitting signals, and the pressure detection circuit 56 is communicatively connected with the electrode, so as to transfer the transmitted signals to the pressure detection circuit 56 to carry out pressure detection for implementing detection and classification processing on the pressure.

In yet another aspect, an embodiment of the present disclosure discloses a display driving method for controlling a touch display apparatus. The touch display apparatus may be any one of the above-mentioned touch display apparatuses. The method includes: when the touch display apparatus is pressed and the first electrode is connected with the second electrode at a pressed position by the conductive spacer, transmitting a signal by one of the first electrode and the second electrode, receiving a signal by the other one of the first electrode and the second electrode, detecting by the pressure detection circuit a conduction condition between the first electrode and the second electrode through the conductive spacer, and determining a conduction electricity quantity correspondingly generated by a pressing operation; and inquiring a preset first control strategy to acquire a first control instruction corresponding to the conduction electricity quantity, and starting a corresponding touch function according to the first control instruction. It should be noted that in the present disclosure, the words “conduction condition” represents a case where the first electrodes and the second electrodes are connected by the conductive spacers, and not only includes the number of the connected first electrodes and second electrodes, but also includes a conduction voltage state or a conduction current state between the first electrodes and the second electrodes after pressing. The implementing principle of pressure detection and classification is described in detail above, and is not repeated herein. According to embodiments of the present disclosure, in a time period of pressure detection, different control signals can be generated according to processing results for different pressure classification signals so as to control different functions of the touch display apparatus. Therefore, a user can simply and conveniently implement control on the touch display apparatus by controlling the pressure applied when the touch display apparatus is pressed.

According to an embodiment of the present disclosure, the second electrode can be a pressure sensing transmitting electrode (Px), and a signal transmitted by the second electrode is detected by utilizing the pressure detection circuit. When the touch display apparatus is subjected to pressure touch, the screen of the touch display apparatus is bent to different degrees due to application of different pressures by the pressing operations, which may cause different numbers of the first electrodes and the second electrodes to be connected through the conductive spacers. The number of the above-mentioned connected electrodes may affect a conduction electricity quantity (e.g., an amount of electric charges) of the electrodes in the pressing operation. At this point, the preset first control strategy is inquired to acquire the first instruction corresponding to the conduction electricity quantity, such that the touch function of the touch display apparatus can be started according to the first control instruction.

According to embodiments of the present disclosure, the first control strategy may be that: the conduction electricity quantities are classified, and for different conduction electricity quantity classifications, different functional control instructions are set. For example, for a first conduction electricity quantity, a first control instruction may initiated so as to start a first touch function; and similarly, for a second conduction electricity quantity, a second control instruction may initiated so as to start a second touch function. After a conduction electricity quantity generated by a pressing operation is detected by utilizing the pressure detection circuit, a conduction electricity quantity range at each level in the first control strategy is inquired, and a conduction electricity quantity range at a target level corresponding to the detected conduction electricity quantity is acquired (e.g., the detected conduction electricity quantity falls within the conduction electricity quantity range at the target level). Then, a corresponding relationship between levels of the electricity quantity range and the functional control instructions in the first control strategy is inquired, and a first control instruction corresponding to the electricity quantity range at the target level is acquired.

According to an embodiment of the present disclosure, the method further includes: when the third electrode transmits a signal (the third electrode may be the touch driving electrode Tx), detecting a capacitance change condition between the third electrode and the other one of the first electrode and the second electrode (one of the first electrode and the second electrode which does not transmit signals) by the touch detection circuit, and determining touch point coordinates corresponding to a touch operation; and inquiring a preset second control strategy to acquire a second control instruction corresponding to the touch point coordinates, and starting a corresponding touch function according to the second control instruction. The second control instruction may include: carrying out partitioning on a display region of the touch display apparatus, where position coordinates in different partitions correspond to different functional control instructions.

In the description of the present disclosure, directional or positional relationships shown by terms such as “up”, “down”, “inner”, “outer” and the like are directional or positional relationships shown as in the drawings, which only means to facilitate description of the present disclosure, but do not request that the present disclosure has to be constructed or operated in the specific directions, and are not limitative of the present disclosure.

In the description of the specification, description of reference terms such as “one embodiment”, “another embodiment” and the like means that specific characteristics, structures, materials or features described in connection with the embodiment are included in at least one embodiment of the present disclosure. In the specification, schematic expressions on the terms do not have to aim at the same embodiment or example. Moreover, the described specific characteristics, structures, materials or features may be combined in a proper manner in any one or more embodiments or examples. Moreover, in a case without conflict, those skilled in the art can carry out connection and combination on different embodiments and examples and characteristics of different embodiments or examples, which are described in the specification. In addition, it should be noted that in the specification, the terms such as “first” and “second” are only used for description, but should not be understood as denotation or suggestion on relative importance or implicit indication on the number of the indicated technical characteristics.

The embodiments of the present disclosure have been shown and described above, but it can be understood that the foregoing embodiments merely are exemplary, and not intended to confine the disclosure, and those skilled in the art can make changes, modifications, replacements and deformations to the foregoing embodiments in the scope of the present disclosure.

What are described above is related to the illustrative embodiments of the disclosure only and not limitative to the scope of the disclosure; any changes or replacements easily for those technical personnel who are familiar with this technology in the field to envisage in the scopes of the disclosure, should be in the scope of protection of the present disclosure. Therefore, the scopes of the disclosure are defined by the accompanying claims.

The present application claims the priority of the Chinese Patent Application No. 201710121412.4 filed on Mar. 2, 2017, which is incorporated herein by reference in its entirety as part of the disclosure of the present application.

1. A touch screen, comprising:
a first substrate;
a second substrate, the second substrate and the first substrate being arranged oppositely; and
a pressure sensing electrode group, wherein the pressure sensing electrode group includes a first electrode, a second electrode and a conductive spacer, the first electrode is positioned on a side of the first substrate which faces the second substrate, the second electrode is positioned on a side of the second substrate which faces the first substrate, an orthographic projection of the first electrode on the second substrate overlaps with an orthographic projection of the second electrode on the second substrate, one end of the conductive spacer is connected with one of the first electrode and the second electrode, and a height of the conductive spacer is smaller than a distance between the first substrate and the second substrate.

2. The touch screen according to claim 1, further comprising:
a touch detection electrode group, wherein the touch detection electrode group includes a third electrode and one of the first electrode and the second electrode.

3. The touch screen according to claim 2, wherein the third electrode is arranged on a side of the first substrate which is far away from the second substrate.

4. The touch screen according to claim 2, wherein the third electrode is arranged between the first substrate and the second substrate.

5. The touch screen according to claim 1, wherein:
the first substrate is a color filter substrate, and the second substrate is an array substrate; or
the first substrate is the array substrate, and the second substrate is the color filter substrate.

6. The touch screen according to claim 1, wherein the first electrode and the second electrode are strip electrodes respectively.

7. The touch screen according to claim 6, wherein the first electrode is formed by arranging a plurality of blocky first sub-electrodes into a strip shape, and the second electrode is formed by arranging a plurality of blocky second sub-electrodes into a strip shape.

8. The touch screen according to claim 2, wherein the third electrode is a strip electrode, and an orthographic projection of the third electrode on the first substrate is perpendicular to the first electrode.

9. The touch screen according to claim 8, wherein the third electrode is formed by arranging a plurality of blocky third sub-electrodes into a strip shape.

10. The touch screen according to claim 1, further comprising:
a first alignment film, wherein the first alignment film is arranged on a surface of the side of the first substrate which faces the second substrate, and at least one portion of the first electrode is embedded into the first alignment film; and
a second alignment film, wherein the second alignment film is arranged on a surface of the side of the second substrate which faces the first substrate, and at least one portion of the second electrode is embedded into the second alignment film.

11. The touch screen according to claim 1, further comprising: a primary spacer, wherein the primary spacer is arranged between the first substrate and the second substrate, the primary spacer is used for supporting the first substrate and the second substrate, and the primary spacer and the conductive spacer are arranged alternately.

12. The touch screen according to claim 2, wherein:
the touch detection electrode group includes the first electrode and the third electrode;
the first electrode is used as a pressure sensing receiving electrode and a touch receiving electrode, the second electrode is used as a pressure sensing driving electrode, and the third electrode is used as a touch driving electrode; or
the first electrode is used as the pressure sensing driving electrode and the touch driving electrode, the second electrode is used as the pressure sensing receiving electrode, and the third electrode is used as the touch receiving electrode.

13. The touch screen according to claim 2, wherein:
the touch detection electrode group includes the second electrode and the third electrode;
the second electrode is used as a pressure sensing receiving electrode and a touch receiving electrode, the first electrode is used as a pressure sensing driving electrode, and the third electrode is used as a touch driving electrode; or
the second electrode is used as the pressure sensing driving electrode and the touch driving electrode, the first electrode is used as the pressure sensing receiving electrode, and the third electrode is used as the touch receiving electrode.

14. A touch display apparatus, comprising:
the touch screen according to claim 1; and
a control circuit, including a touch detection circuit and a pressure detection circuit, wherein:
the pressure detection circuit is electrically connected with the pressure sensing electrode group, and is configured to detect a touch pressure applied to the touch screen; and
the touch detection circuit is electrically connected with a touch detection electrode group, and is configured to detect a touch position on the touch screen.

15. A display driving method for the touch display apparatus according to claim 14, comprising:
when the touch display apparatus is pressed and a first electrode and a second electrode at a pressed position are electrically connected by a conductive spacer, transmitting a first signal by one of the first electrode and the second electrode, receiving a second signal by the other one of the first electrode and the second electrode, detecting a conduction condition between the first electrode and the second electrode through the conductive spacer by the pressure detection circuit, and determining a conduction electricity quantity correspondingly generated by a pressing operation; and
inquiring a preset first control strategy to acquire a first control instruction corresponding to the conduction electricity quantity, and starting a corresponding touch function according to the first control instruction.

16. The display driving method according to claim 15, wherein inquiring the preset first control strategy to acquire the first control instruction corresponding to the conduction electricity quantity includes:
inquiring a conduction electricity quantity range at each level in the first control strategy, and acquiring a electricity quantity range at a target level corresponding to the detected conduction electricity quantity; and
inquiring a corresponding relationship between levels of electricity quantity ranges and functional control instructions in the first control strategy, and acquiring the first control instruction corresponding to the electricity quantity range at the target level.

17. The display driving method according to claim 15, further comprising:
when the third electrode transmits a third signal, detecting a capacitance change condition between the third electrode and the other one of the first electrode and the second electrode by the touch detection circuit, and determining touch point coordinates corresponding to a touch operation; and
inquiring a preset second control strategy to acquire a second control instruction corresponding to the touch point coordinates, and starting a corresponding touch function according to the second control instruction.
